(19) United States
(12) Patent Application Publication
(10) Pub. No.: US 2012/0312518 A1
(43) Pub. Date: Dec. 13, 2012

(54) RESIN-IMPREGNATED BODY MADE OF SILICON CARBIDE AND METHOD OF PRODUCING THE RESIN-IMPREGNATED BODY

(75) Inventors: MARCUS FRANZ, SCHWABMUNCHEN (DE); OSWIN ÖETTINGER, MEITINGEN (DE)

(73) Assignee: SGL CARBON SE, WIESBADEN (DE)

(21) Appl. No.: 13/493,074

(22) Filed: Jun. 11, 2012

Related U.S. Application Data
(63) Continuation of application No. PCT/EP2010/067766, filed on Nov. 18, 2011.

(30) Foreign Application Priority Data
Dec. 11, 2009 (DE) 10 2009 054 574.3

(51) Int. Cl. F28F 21/02; B29C 70/86; B29B 15/10

(52) U.S. Cl. 165/180; 264/279; 156/172

(57) ABSTRACT

A body contains an open-pore silicon carbide which is at least partially impregnated with a resin. A method produces such a body and includes the steps of a) providing an open-pore silicon carbide, b) at least partially impregnating the open-pore silicon carbide with the resin and c) curing the resin. The body can be used as a pipe in a heat exchanger.

### CROSS-REFERENCE TO RELATED APPLICATION

This application is a continuation application, under 35 U.S.C. §120, of copending international application No. PCT/EP2010/067766, filed Nov. 18, 2010, which designated the United States; this application also claims the priority, under 35 U.S.C. §119, of German patent application No. DE 10 2009 054 574.3, filed Dec. 11, 2009; the prior applications are herewith incorporated by reference in their entireties.

### BACKGROUND OF THE INVENTION

1.Field of the Invention

The objects of the present invention are a resin-impregnated body made of silicon carbide, a method for producing such bodies, and use thereof as a pipe in a heat exchanger.

Heat exchanger pipes or blocks usually include graphite. Graphite has good thermal conductivity, is tough, pressure-resistant and resistant to thermal loads and corrosion.

Material composites of graphite with a resin are also widely used in many technical applications. For example, graphite is impregnated with phenolic resin to form a leak-proof material in the manufacture of appliances and pressure vessels. In this case, the previously open-pore material becomes a semi-finished product in the form of a block, a panel or a pipe. Phenolic resin is used as the impregnating agent, because phenolic resin has sufficient thermal resistance and is also chemically highly resistant to acids.

The disadvantage of the substance that has undergone such post-treatment is that it is not very resistant to erosion, so it can only be approved for use with low flow velocities in fluid applications (heat exchangers, for example). The permitted flow velocity is reduced further if the fluids are charged with abrasive particles. Consequently, a self-cleaning effect in heat exchanger pipes or blocks due to fast flowing media that may be charged with particles, does not take place or cannot be created. However, such a self-cleaning effect would be desirable and could be applied for example for concentrating P₂O₅. The advantage this would yield is reflected in less stoppage time, because the cleaning intervals would be extended or in the best possible case cleaning could be dispensed with altogether.

### SUMMARY OF THE INVENTION

It is accordingly an object of the invention to provide a resin-impregnated body made of silicon carbide and a method of producing the resin-impregnated body which overcome the above-mentioned disadvantages of the prior art methods and devices of this general type, resulting in a material that is highly resistant to erosion as well as durable with regard to abrasion and leak-proof.

According to the invention, a body is provided that contains open-pore silicon carbide and is at least partially impregnated with resin. Such a body is highly resistant to erosion and abrasion, and is leak-proof. Such a body is also an excellent conductor of heat. The thermal conductivity of silicon carbide is not degraded by the resin impregnation. The resin is preferably heat-cured.

The body is preferably constructed in such manner that the resin is deposited in the open pores of the open-pore silicon carbide. There is preferably no resin film on the surface of the body. That is to say, the silicon carbide is not completely covered by the resin, rather the open pores of the silicon carbide hold the resin with the result that the silicon carbide and the resin together form a sealed body.

The silicon carbide has open pores. The open pores may be interconnected in many different ways. The open-pore silicon carbide then contains a porous silicon carbide framework or network. During impregnation, the resin penetrates the silicon carbide through this network of interconnected pores and under suitable conditions may also fill them up completely. The network of pores then becomes a network of resin. In this way, a body is obtained that contains two individually cohesive networks. The first network contains a contiguous framework of silicon carbide. The second network contains the resin that has penetrated the pores of the silicon carbide. The two networks together, the silicon carbide network and the resin network, provide the outstanding properties of the body according to the invention. The body according to the invention is highly impermeable to liquids and gases if the pore network of the silicon carbide is completely filled with cured resin.

In a preferred embodiment, the resin represents a thermosetting plastic. Thermosetting plastics are ideally suited to sealing the open pores of the silicon carbide. Examples of suitable thermosetting plastics include phenolic resin and epoxy resin.

The resin preferably represents a phenolic resin. More preferably, the resin represents a resol. The term resol is used to refer to a phenolic resin in which cross-linking is catalyzed in the form of condensation by bases with an excess quantity of formaldehyde. In this process, the resin passes sequentially through the states of a resol, a resitol and a resit, and volatile byproducts of the reaction escape. In the first stage (state A), resol, the resin is still soluble and meltable, in the second stage (state B), resitol, the resin is still swellable and softens when heated, but in the third stage (state C), resit, full cross-linking has taken place and the resin is insoluble and unmeltable. The body preferably contains cured phenolic resin, in particular the open pores of the silicon carbide preferably contain cured resol resin.

Resin systems that are suitable for use as the epoxy resin are those that contain bisphenol A diglycidyl ether or bisphenol F diglycidyl ether. Diphenylbenzene may also be used for sealing. Preferably, a silazane resin system may also be used.

In a preferred embodiment, the proportion of resin by weight is up to 50% relative to the body. This means that the silicon carbide is able to absorb up to 100% of its own weight in resin. In particularly preferred embodiment, however, the silicon carbide is able to absorb only a small amount, for example only 20% by weight of resin relative to the body's own weight.

In a preferred embodiment, the open-pore silicon carbide has an open porosity from 0 to 80% by volume and a gross density from 1.9 to 3.5 g/cm³.

More preferably, the open-pore silicon carbide has an open porosity from 5 to 15% by volume and a gross density from 2.5 to 3.1 g/cm³. The pore size of the silicon carbide may vary, though a uniform distribution of a predetermined pore size is preferred. The pore size is preferably in the range from 0.05 to 1.5 μm, more preferably from 0.1 to 1.0 μm, more preferably still from 0.2 to 0.5 μm. In a preferred embodiment, the silicon carbide contains 5% open pores with a pore size of 1 μm and 8-10% open pores with a pore size of 0.2 μm.

It is also preferred if the open-pore silicon carbide has an Si content of less than 0.50%, more preferably 0.35%. More preferably still, the open-pore silicon carbide is a silicon carbide that contains no open-pore Si. For example, the open-pore silicon carbide is recrystallized silicon carbide (RSiC). Alternatively, the open-pore silicon carbide may be nitride-bonded silicon carbide (NSiC).

The silicon carbide may contain at least one ceramic or mineral filler material, in which case the filler materials are to be selected on the basis of the intended application. Examples of filler materials include substances from the group of naturally occurring flake graphites, synthesized electrographites, carbon blacks or carbons, graphite or carbon fibers. Additionally, ceramic or mineral filler materials in granule, platelet or fiber form such as silicates, carbonates, sulphates, oxides, glasses or selected mixtures thereof may be used. The open-pore silicon carbide is particularly preferably reinforced with carbon fibers, in other words it is a “C/SiC material”.

In a preferred embodiment, at least one carbon fiber is wrapped around and reinforces the silicon carbide impregnated with resin. At least one carbon fiber is preferably wrapped around the impregnated silicon carbide in the manner of a mesh under tension. This cladding serves to increase the body's resistance to pressure.

The body may be of any shape. The body preferably has the form of a block, panel or pipe. In a yet further preferred embodiment, the silicon carbide impregnated with resin is constructed in the form of a pipe. Such pipes lend themselves well to use as heat exchangers, because they are excellent thermal conductors and they allow self-cleaning with fast-flowing media. At least one carbon fiber is wrapped around the pipe in the manner of a highly tensioned mesh, thereby further increasing its resistance to pressure. The specific behavior of the carbon fiber ensures that the cladding remains very tightly wrapped around the pipe even when the load on the pipe varies and/or rises considerably. Because carbon fiber has a negative coefficient of thermal expansion, the cladding becomes wrapped even tighter as the temperature rises, its rupture and leak pressure is greater at elevated temperatures than at room temperature. The carbon fiber reinforcement improves the properties of resin-impregnated silicon carbide pipes as follows: the rupture pressure is increased, the pipe becomes less susceptible to vapor shocks and conditions in which the operating pressure is exceeded, since the rupture pressure of the pipe at room temperature is 30 to 40% higher than that of the unreinforced pipe depending on the dimension of the pipe.

The body according to the invention may be produced by the following method, which contains the steps of:

a) providing an open-pore silicon carbide,
b) at least partially impregnating the open-pore silicon carbide with resin, and
c) curing the resin.

The method ensures that the leak-tightness of the body typically required in apparatus construction is achieved by the impregnation of the silicon carbide with the resin. In the method according to the invention, the resin is forced into the open pores in the silicon carbide, preferably in the vacuum pressure method, filling them completely. The resin is then cured at an elevated temperature.

The impregnation with resin and curing of the resin serves to increase the strength of the body by a factor of 2 to 3 compared with the silicon carbide before it is impregnated, without any loss of its thermal conductivity.

Step a) of the method according to the invention particularly involves the provision of recrystallized silicon carbide. The silicon carbide provided preferably has a gross density between 1.9 and 3.5 g/cm³. Also preferably, that silicon carbide provided in step a) has as open porosity of 5 to 15% by volume. In particular, the silicon carbide is present in the desired form of the component to be manufactured. The silicon carbide is preferably provided in the form of a pipe or a heat exchanger plate.

Step b) of the method according to the invention particularly involves filling the open pores of the silicon carbide. Once it has been introduced into the pores of the silicon carbide, the resin has no tendency to run out again. Besides its coating behavior, the following aspects are particularly important.

1. Particular techniques are preferably used for the impregnation, such as vacuum or vacuum-pressure impregnation. It is only possible to fill a portion of the existing pores by using such techniques, for example so that the filling resistances—encountered when flowing through narrow pore throats—may be overcome. If special measures are not used, once it has been introduced into the body the resin cannot escape again.

2. If a resol resin is used, as was explained previously it gradually becomes more viscous as it passes through the stages A to C. This increase in viscosity is low at low temperatures (storage stability, state A, resol), but at higher temperatures it becomes very pronounced, the resin gels (state B, resitol). It is practically impossible for resin that has gelled in this way to run out of the pores in the silicon carbide again. The insoluble and unmeltable resin obtained by cross-linking (state C, resit) is also unable to escape from the pores in the silicon carbide.

The resin used in step b) preferably has a viscosity in the range from 5 to 4000 mPa·s. The resin may be used in its pure form for the impregnation or it may be dissolved in a suitable solvent. For example, the resin may be dissolved in water, possibly in combination with alcohols. The resin content in the solvent depends on the desired consistency of the resin to be used for the impregnation and on the pore size of the open pores in the silicon carbide.

The impregnation of the silicon carbide carried out in step b) of the method according to the invention may be performed in a dipping process. The silicon carbide preferably undergoes a deaeration treatment before the impregnation. The resin, which may have been dissolved, may also be subjected to a deaeration process before the impregnation. For example, a dipping process preceded by evacuation of a vessel containing the silicon carbide and flooding of the evacuated vessel with the resin, possibly dissolved in a solvent, so that the silicon carbide is dipped or immersed in the resin. The vessel may also be charged with a gas pressure after it has been flooded with the resin. The silicon carbide impregnated with the resin may also undergo a deaeration treatment to evacuate gas-phase components in the resin and the silicon carbide at reduced pressure. The deaeration treatment may be repeated any number of times.

If one only intends to impregnate the near-surface area or carry out partial impregnation of the silicon carbide, the duration of the impregnation may be abbreviated, or the areas from which the impregnation is to emanate may be swept in or sprayed correspondingly, or only part of the silicon carbide may be dipped. Following this treatment, excess resin is removed from the surface by wiping for example.

Step b) of the method according to the invention may be repeated as often as desired. In the process according to the invention, the silicon carbide is able to absorb up to 100% of its own weight in resin depending on the porosity of the silicon carbide and the volume of open pores associated therewith. Given a smaller volume of open pores, the silicon carbide is also only able to absorb a small amount, for example only 20% by weight of resin relative to its own weight.

The resin is then cured. The curing process of step c) is preferably carried out at temperatures from 120 to 180° C. within a period of up to two hours, in an unpressurized environment or under pressures from 0.5 to 1.5 bar. At elevated temperatures, that is to say at 170 to 180° C., a curing time of up to 15 minutes is generally sufficient. The higher the temperature, the shorter the curing time.

The body produced by the method according to the invention contains no flaws such as bubbles or cracks, which may be caused by reactions of the resin while it is curing. The body is also able to be produced at low cost. It is corrosion-resistant, a good conductor of heat, and depending on the degree of sealing it may be classified anywhere in a range from technically liquid permeable to technically gas impermeable.

A preferred embodiment of the method according to the invention includes an additional step following step c).

Step d) Wrapping at least one carbon fiber around the body. The silicon carbide impregnated with resin is thus reinforced with at least one carbon fiber. This in turn increases the body's resistance to pressure. At least one carbon fiber in the form of a mesh is preferably wrapped very tightly around the resin-impregnated silicon carbide.

In the method according to the invention, phenolic resin is preferably used as the resin. Phenolic resin is sufficiently thermally resistant and is extremely resistant to acids, so it represents an ideal material from which to manufacture the body according to the invention.

In a preferred embodiment of the method according to the invention, in step a) open pore silicon carbide is provided that contains at least one ceramic or mineral filler material. Preferably, a carbon-fiber reinforced silicon carbide (C/SiC) is provided.

The body according to the invention may be for example a pipe, a block or a tube sheet for heat exchangers that are exposed to high mechanical loads and/or extremely corrosive media and solvents as well as all other components exposed to high thermal and pressure loads. In particular, it is an ideal material for building heat exchangers because it is an excellent heat conductor and is leak-proof. The body according to the invention is particularly well suited for use as heat exchanger piping, because it is exceptionally resistant to erosion, so that it is capable of withstanding flow velocities and it is thus possible for the pipe to undergo a self-cleaning process with fast flowing media that may be charged with particles.

A heat exchanger that contains a body according to the invention is constructed for example as now described. The heat exchanger contains a mantle, that includes an inlet and an outlet for a fluid. Baffle plates may also be arranged inside the heat exchanger to project into the interior of the mantle from the mantle and are disposed parallel with each other in such manner as to assist with the circulation of the fluid inside the mantle. In addition, at least one pipe bundle is arranged inside the mantle. The ends of the pipes in the pipe bundle are arranged on a tube sheet that is connected to the mantle in liquid impermeable manner. The tube sheet has at least one inlet and one outlet for another fluid, which circulates in the pipes of the pipe bundle and which is at a different temperature from that of the fluid in the mantle for the purpose of transferring heat between the two fluids. The body according to the invention is particularly suitable for use as a pipe in the pipe bundle of the heat exchanger. Because of its outstanding strength, a pipe made from the body according to the invention is able to sustain a self-cleaning process with a rapidly circulating fluid that may be charged with particles. The other components described in the aforegoing or if applicable additionally installed components are made from graphite, coated graphite, metal plates or rubberized metal plates.

Other features which are considered as characteristic for the invention are set forth in the appended claims.

Although the invention is described herein as embodied in a resin-impregnated body made of silicon carbide and a method of producing the resin-impregnated body, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying examples.

### DETAILED DESCRIPTION OF THE INVENTION

### Example

A SiC pipe having dimensions 35×30 mm was used. A pipe with designation Halsic-R is commercially available from Morgan Advanced Ceramics W Haldenwanger Technische Keramik GmbH & Co K G, Waldkraiburg, Germany. Five samples were analyzed before the silicon carbide pipe with impregnated with phenolic resin. The measured properties of these samples are summarized in table 1 together with standard deviation s. The properties were determined in accordance with the DIN test standard. The permeability of the samples could not be measured because the material is too untight.

TABLE 1

| Sample no. | | 1 | 2 | 3 | 4 | 5 | s |
|---|---|---|---|---|---|---|---|
| Module of | 1* | 131.3 | 130.9 | 134.3 | 133.6 | 132.5 | 1.7 |
| elasticity (GPa) | | | | | | | |
| Strength (MPa) | 1* | 23.3 | 35.2 | 37.4 | 40.8 | 34.2 | 7.6 |
| Pore volume Ø | | 5.0 | 4.2 | 5.0 | 5.8 | 5.0 | 0.7 |
| 1 μm | | | | | | | |

*1 = longitudinal sample

The properties of the silicon carbide pipe after treatment with phenolic resin are summarized together with standard deviation s in table 2. The pore volume of the samples was not measured because the pores of the silicon carbide were filled with resin after impregnation and therefore no longer existed.

TABLE 2

| Sample no. | | 1 | 2 | 3 | 4 | 5 | s |
|---|---|---|---|---|---|---|---|
| Module of | 1* | 115.6 | 119.1 | 119.7 | 122.6 | 119.3 | 2.9 |
| elasticity (GPa) | | | | | | | |
| Strength (MPa) | 1* | 93.7 | 81.8 | 84.0 | 79.9 | 84.8 | 6.2 |
| Permeability | 6* | 2.3 × | 2.2 × | 1.2 × | 2.6 × | 2.1 × | 6.1 × |
| cm²/s | | 10⁻⁵ | 10⁻⁵ | 10⁻⁵ | 10⁻⁵ | 10⁻⁵ | 10⁻⁶ |

*1 = longitudinal sample, 6 = transverse sample

As may be seen by comparing Tables 1 and 2, the modulus of elasticity of the silicon carbide impregnated with phenolic resin is slightly lower than that of the untreated pipe, whereas the strength of the impregnated pipe increases by a factor of 2 to 3. The strength of the pipe is increased considerably by the impregnation with resin.

1. A heat exchanger apparatus selected from the group consisting of a heat exchanger pipe and a heat exchanger plate, the heat exchanger apparatus comprising:
an open-pore silicon carbide network having pores being at least partly impregnated with a cured phenolic resin.

2. The heat exchanger apparatus according to claim 1, wherein said cured phenolic resin has been impregnated in such a manner that the heat exchanger apparatus does not have a closed resin film on a surface.

3. The heat exchanger apparatus according to claim 1, wherein a proportional weight of said cured phenolic resin is up to 50%.

4. The heat exchanger apparatus according to claim 1, wherein said open-pore silicon carbide network has an open porosity from 0 to 80% by volume and a gross density from 1.9 to 3.5 g/cm³.

5. The heat exchanger apparatus according to claim 1, wherein said open-pore silicon carbide network contains at least one mineral filler material.

6. The heat exchanger apparatus according to claim 1, wherein said open-pore silicon carbide network is impregnated with resin and is wrapped in and reinforced by at least one carbon fiber.

7. A method for producing a heat exchanger apparatus selected from the group consisting of a heat exchanger pipe and a heat exchanger plate, which comprises the steps of:
providing an open-pore silicon carbide network having pores;
impregnating the pores of the open-pore silicon carbide network with a phenolic resin; and
curing the phenolic resin.

8. The method according to claim 7, which further comprises wrapping at least one carbon fiber around the heat exchanger apparatus after the phenolic resin is cured.

9. The method according to claim 7, wherein the open-pore silicon carbide network contains at least one mineral filler material.
